(19) United States
(12) Patent Application Publication
(10) Pub. No.: US 2006/0098106 A1
(43) Pub. Date: May 11, 2006

(54) Photography device and photography processing method

(75) Inventor: Seiji Tanaka, Saitama-ken (JP)

Correspondence Address: TAIYO CORPORATION, 401 HOLLAND LANE, #407, ALEXANDRIA, VA, 22314, US

(73) Assignee: FUJI PHOTO FILM CO., LTD.

(21) Appl. No.: 11/262,749

(22) Filed: Nov. 1, 2005

(30) Foreign Application Priority Data
Nov. 11, 2004 (JP) 2004-327674

(51) Int. Cl. H04N 5/76

(52) U.S. Cl. 348/231.99

(57) ABSTRACT

A photography device and photography processing method which are capable of image-recording and display without a time lag therebetween when photography is instructed. A delay duration detection section acquires, via an A/D converter, image data obtained by photography by an image capture device, also acquires image data of an image frame which is shown at a display, and detects a number of frames by which the sets of image data are separated, to serve as a delay duration (corresponding to a time lag from operation of a shutter button until display at the display). Image data in an amount corresponding to the delay duration is stored at a temporary storage memory and, when the shutter button is fully pressed, an image frame counted back by the delay duration is selected from the image frames stored in the temporary storage memory, and is both recorded and shown at the display.

### CROSS-REFERENCE TO RELATED APPLICATION

This application claims priority under 35 USC 119 from Japanese Patent Application No. 2004-327674, the disclosure of which is incorporated by reference herein.

### BACKGROUND OF THE INVENTION

1. Field of the Invention

The present invention relates to a photography device and a photography processing method, and particularly relates to a photography device and photography processing method for photographing subject images, recording the photographed subject images as image data, and displaying subject images on the basis of image data representing the photographed subject images.

2. Description of the Related Art

In recent years, digital cameras have been commonly used as photography devices for photographing subject images. A conventional digital camera (a digital still camera, digital video camera or the like) records images which have been acquired by an image capture device, such as a CCD or the like, in the form of digital image data at a recording medium, such as an internal memory, IC card or the like provided inside the digital camera or a magnetic tape or the like. On the basis of the recorded digital image data, images can be recorded at recording paper by printing and the images acquired by photography can be displayed at a monitor. Many of these digital cameras are ordinarily provided with liquid crystal monitors. Thus, the photographed images can be immediately displayed at the liquid crystal monitor, and the liquid crystal monitor can be employed as a viewfinder.

Now, although digital cameras have an advantage in that photographed images can be immediately verified at a liquid crystal monitor or the like, there is a disadvantage in that, because of problems with responsiveness of image capture devices, an image that is captured at a time of photography is delayed relative to a shutter operation, and a moment for shooting may be lost. Accordingly, technologies have been proposed to prevent delays relative to shutter operations.

For example, in a technology disclosed in Japanese Patent Application (JP-A) Laid-Open No. 2002-271673, a digital camera is provided with a time lag measurement mode. A duration (time lag) from a decision according to a photographer's view until a shutter button is pressed is measured in advance. Preparation for photography such as auto-exposure/autofocus (AE/AF) processing and the like is completed, and then capture of images is commenced without waiting for the shutter button to be pressed. The captured images are sequentially stored in a primary storage memory, and image data corresponding to at least the time lag is stored. When the shutter button is pressed, an image of a time counted back by the time lag from the moment of shutter operation is selected as an image to be recorded, and is written to a recording medium. Thus, the loss of a shooting opportunity can be avoided.

Further, technologies similar to JP-A No. 2002-271673, such as a technology disclosed in JP-A No. 11-136557 and the like, have been proposed. The technology disclosed in JP-A No. 11-136557 suggests continuously capturing image data and temporarily storing plural frames of the image data, and selecting and storing the image data that is judged to be the most worthwhile by judging means for judging the quality of photographic images. This technology is similar in that plural frames of image data are acquired.

However, in practice, a time lag from image capture by an image capture device until display at a display device such as a liquid crystal monitor or the like is longer than a time lag relating to a shutter operation. Thus, there has been a problem in that an image which is displayed at the moment that a shutter is pressed is time-shifted from an image which is actually stored.

### SUMMARY OF THE INVENTION

The present invention has been devised in consideration of the above, and enables image-recording and display without a time lag at a time of a photography instruction.

A photography device of a first aspect of the present invention includes: an image capture device, which acquires image data representing a subject image by photographing the subject image; an instruction section for instructing photography; a display section, which implements display on the basis of the image data acquired by the image capture device; an acquisition section which acquires a delay duration, which is the duration of the delay from acquisition of the image data by the image capture device until the display section displays an image; a storage section, which stores the image data which the image capture device acquires; and a selection section which, at a time at which photography is instructed by the instruction section, selects, from the image data stored at the storage section, image data that corresponds to a time previous to the time at which photography is instructed by the delay duration acquired by the acquisition section.

A photography processing method of a second aspect of the present invention includes: an image capture step, for acquiring image data representing a subject image by photographing the subject image; a display step, for implementing display on the basis of the image data acquired by the image capture step; an acquisition step, for acquiring a delay duration, which is the duration of the delay from acquisition of the image data in the image capture step until an image is displayed in the display step; a storage step, for storing the image data acquired by the image capture step; and a selection step of, at a time at which photography is instructed, selecting, from the image data stored by the storage step, image data that corresponds to a time previous to the time at which photography is instructed by the delay duration acquired in the acquisition step.

### BRIEF DESCRIPTION OF THE DRAWINGS

FIGS. 1A and 1B are perspective views showing the exterior of a digital camera relating to a first embodiment of the present invention.

FIG. 2 is a block diagram showing structure of an electrical system of the digital camera relating to the first embodiment of the present invention.

FIG. 3 is a functional block diagram showing detailed structure for when an image is to be displayed at a display of the digital camera relating to the first embodiment of the present invention.

FIG. 4 is a flowchart showing an example of flow of operations of the digital camera relating to the first embodiment of the present invention.

FIG. 5 is a chart for explaining an image frame which is displayed and recorded when a shutter button is operated.

FIG. 6 is a functional block diagram showing detailed structure for when an image is to be displayed at a display of a digital camera relating to a second embodiment of the present invention.

FIG. 7 is a flowchart showing an example of flow of operations of the digital camera relating to the second embodiment of the present invention.

FIG. 8 is a functional block diagram showing detailed structure for when an image is to be displayed at a display of a digital camera relating to a third embodiment of the present invention.

FIG. 9 is a flowchart showing an example of flow of operations of the digital camera relating to the third embodiment of the present invention.

### DETAILED DESCRIPTION OF THE INVENTION

Herebelow, examples of embodiments of the present invention will be described with reference to the drawings.

First Embodiment

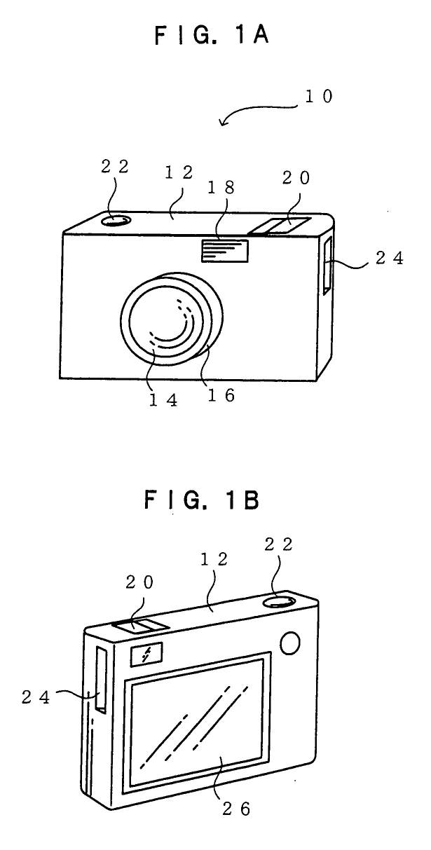

FIGS. 1A and 1B are perspective views showing the exterior of a digital camera relating to a first embodiment of the present invention.

As shown in FIGS. 1A and 1B, a main body 12 of a digital camera 10 is substantially box-shaped. A lens barrel 16, at which a lens 14 is mounted, is provided at the middle of a front face side of the main body 12.

A flash 18 is provided upward of the lens 14 of the main body 12. The flash 18 is for emitting light to assist in cases of photography in low illumination and the like.

A power switch 20 and a shutter button 22 are provided at an upper face of the main body 12, at a right side and a left side as viewed from the front face, respectively. A slot 24, at which a memory card (not shown) can be mounted, is provided at a right side face of the main body 12 as viewed from the front face.

The shutter button 22 is structured to be operable to two positions: a half-press and a full-press. AE (auto-exposure) and AF (autofocus) are implemented when the shutter button 22 is half-pressed, and a photography instruction is implemented when the shutter button 22 is fully pressed.

A display 26, such as a liquid crystal display or the like, is provided at the middle of a rear face side of the main body 12. The display 26 implements display of photographed images and also functions as a viewfinder.

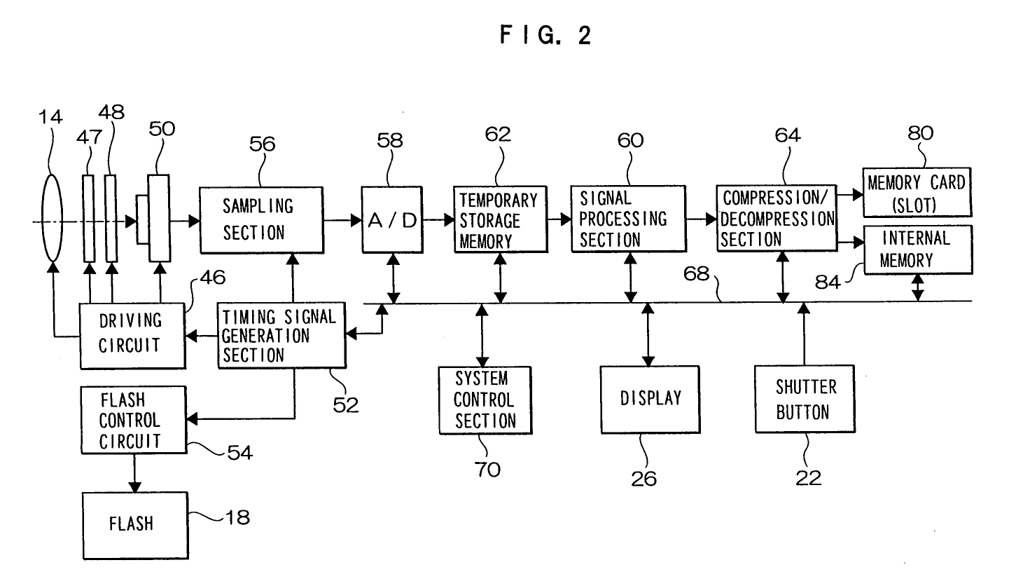

FIG. 2 is a block diagram showing structure of an electrical system of the digital camera 10 relating to the first embodiment of the present invention.

The lens 14 is more specifically constituted with a zoom lens (a variable-focusing distance lens). A zoom mechanism is driven by a driving circuit 46. An autofocus (AF) lens 47 is also provided, and the AF lens 47 is similarly driven by the driving circuit 46. Herein, instead of the zoom lens, a variable-focusing distance lens which is provided only with the AF lens 47 could be employed.

An image capture device 50, which is structured with a CCD sensor or the like, is disposed inside the main body 12 at a position corresponding to a focusing position of the lens 14. Light that is reflected from a subject and enters the lens 14 is imaged at a light-receiving face of the image capture device 50. At each of numerous photoelectric conversion cells, which are arranged in a matrix on the light receiving-face of the image capture device 50, analog signals which represent received light amounts are outputted as image signals. The image capture device 50 is driven to output the image signals with timings which are synchronized with timing signals generated by a timing signal generation section 52, which is connected to the driving circuit 46.

An aperture 48 is provided between the lens 14 and the image capture device 50. The aperture 48 may be structured by a single, continuously variable aperture or may have a structure which switches between plural apertures with different aperture values.

A flash control circuit 54 is also connected to the timing signal generation section 52. The flash control circuit 54 controls light emissions of the flash 18. In cases in which low illumination is detected, or in cases in which light emission is instructed by a user and the like, the flash 18 is controlled to emit light with a timing which is synchronized with a timing signal generated by the timing signal generation section 52.

From a signal output end of the image capture device 50, a sampling section 56, an A/D converter 58, a temporary storage memory 62, a signal processing section 60 and a compression/decompression section 64 are connected in this order. These are respectively connected to a system bus 68, and are controlled overall by a system control section 70, which is also connected to the system bus 68.

At the sampling section 56, the image signals outputted from the image capture device 50 are sampled with timings which are synchronized with timing signals generated by the timing signal generation section 52, and are amplified and outputted to the A/D converter 58. The sampling section 56 is structured to include an unillustrated CDS (correlated double sampling) section. The CDS section includes, for example, a clamping circuit and a sample-holding circuit. In accordance with timing signals from a timing signal generation section, the clamping circuit clamps various kinds of noise which, when a CCD-type image capture device is employed, are fundamentally generated by that device. The sample-holding circuit holds analog voltage signals in accordance with timing signals. The CDS section removes noise components and feeds the image signals to the A/D converter 58 in the form of analog output signals. The image signals which have been outputted from the sampling section 56 are converted to digital image data by the A/D converter 58, and are temporarily stored at the temporary storage memory 62, which is constituted by RAM or the like. Herein, the temporary storage memory 62 connected to the system bus 68 temporarily stores image data of plural image frames for at least a number of frames in an amount corresponding to a time lag, for the purpose of eliminating a mismatch between an image which is recorded when the shutter button 22 is operated to instruct photography and an image which is displayed at the display 26.

At the signal processing section 60, various treatments, such as gain correction, color correction, gamma correction, Y/C conversion and the like, are applied to inputted image data. When the shutter button 22 is operated, from the image data that has been stored at the temporary storage memory 62, image data corresponding to a timing of the operation of the shutter button 22 is outputted to the signal processing section 60, and the various treatments are applied by the signal processing section 60. Thereafter, the image data is compressed at the compression/decompression section 64 and then stored at an internal memory 84 or at a memory card 80 which is mounted at the slot 24.

The display 26 is also connected to the system bus 68. The display 26 is capable of displaying images based on image data obtained by photography (for example, display of a through-image, display of a still image which has been photographed, and the like). Herein, detailed structure for displaying images at the display 26 will be described later.

The shutter button 22 and an unillustrated control switch and the like are also connected to the system bus 68. Controls are implemented in accordance with operation of the button and switch.

That is, in a case in which, in accordance with operation of the control switch or the like, storage of image data to the internal memory 84 or to the memory card 80 mounted at the slot 24 is instructed, the system control section 70 reads image data which has been temporarily stored at the temporary storage memory 62 by photography and transfers the image data to the compression/decompression section 64. Hence, the image data is stored at the internal memory 84 or the memory card 80 after being compressed by the compression/decompression section 64. Here, depending on a mode at the time of photography, image data may also be stored at the internal memory 84 or the memory card 80 without being compressed.

Further, when playback (display) of an image represented by image data which has been stored at the internal memory 84 or the memory card 80 mounted at the slot 24 is instructed, the image data is read from the internal memory 84 or the memory card 80 mounted at the slot 24, the image data that has been read is decompressed (expanded) by the compression/decompression section 64, and is thereafter temporarily stored at the temporary storage memory 62. Hence, display (playback) of the image at the display 26 is carried out using the image data which is temporarily stored in the temporary storage memory 62.

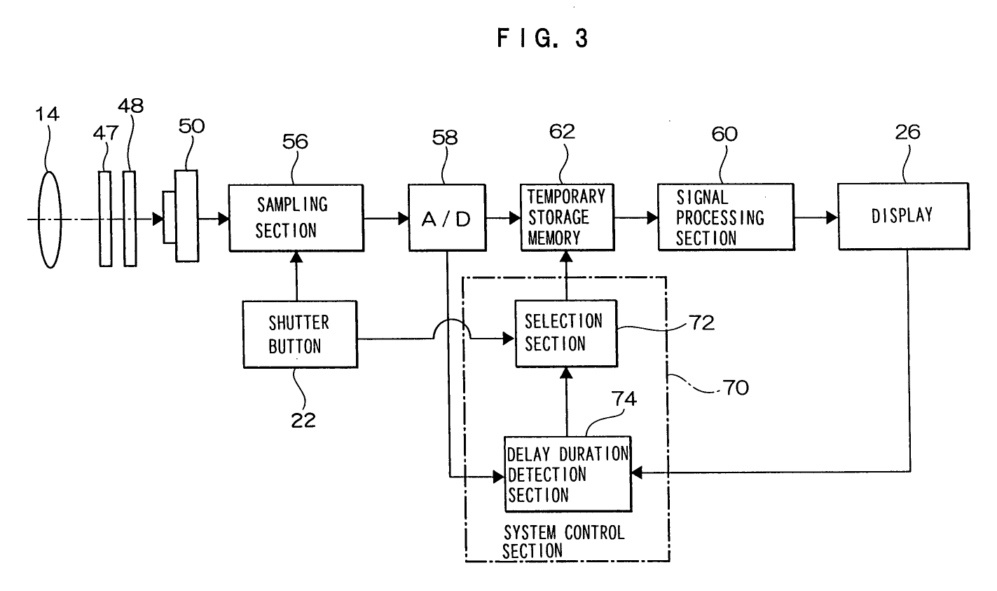

Next, detailed structure for image display at the display 26 of the digital camera 10 relating to the first embodiment of the present invention will be described. FIG. 3 is a functional block diagram showing the detailed structure for when an image is to be displayed at the display 26 of the digital camera 10 relating to the first embodiment of the present invention.

As has been described above, a subject image is focused at the image capture device 50, via the lens 14, the AF lens 47 and the aperture 48. The subject image is outputted from the image capture device 50 in the form of image data, and is outputted to the signal processing section 60 while being stored at the temporary storage memory 62 via the above-described sampling section 56 and A/D converter 58. Then, after various processes have been performed by the signal processing section 60, the image data is outputted to the display 26. Thus, a through-image is displayed at the display 26.

The system control section 70 is structured to include a selection section 72 and a delay duration detection section 74. The delay duration detection section 74 acquires image data, which is obtained by photography by the image capture device 50, from the A/D converter 58, also acquires image data of an image frame which is displayed at the display 26, and detects a number of frames of a delay between the respective sets of image data to serve as a delay duration (i.e., a delay duration corresponding to a time lag from operation of the shutter button 22 until display at the display 26). In the present embodiment, the delay duration detection section 74 detects a delay frame count to serve as the delay duration, but could also calculate the delay duration itself, from the delay frame count and a sampling rate of the sampling section 56.

The selection section 72 acquires the delay duration detected by the delay duration detection section 74 (i.e., the delay frame count). When the shutter button 22 is operated, of the plural image frames stored at the temporary storage memory 62, the selection section 72 selects image data which represents an image frame counted back by the delay duration and outputs this image data to the signal processing section 60.

Now, an example of operation of the digital camera 10 relating to the first embodiment of the present invention, which is structured as described above, will be described.

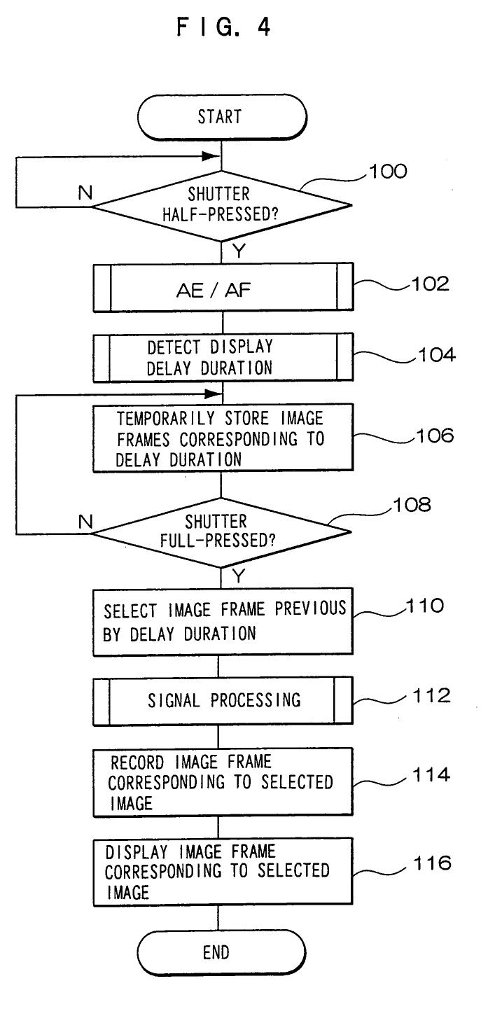

FIG. 4 is a flowchart showing an example of flow of operations of the digital camera 10 relating to the first embodiment of the present invention.

First, in step 100, the system control section 70 determines whether or not the shutter button 22 has been half-pressed. When this determination is negative, the system control section 70 waits, until the determination is positive, and then proceeds to step 102.

In step 102, AE/AF processing is performed. Known techniques can be employed for the AE/AF processing. For example, for the AE processing, control is performed by the system control section 70 so as to calculate evaluation values for adjusting the aperture 48, on the basis of light amounts of image data outputted by the image capture device 50, and to adjust the aperture 48. Further, for the AF processing, control is performed by the system control section 70 to detect a position of the AF lens 47 at which a contrast value of image data outputted by the image capture device 50 is maximized and move the AF lens 47, and to detect a position of the AF lens 47 at which a frequency of the image data is at least a predetermined high-frequency component and move the AF lens 47.

Then, in step 104, display delay duration detection processing is performed. For this processing, image data provided by photography by the image capture device 50 is acquired by the delay duration detection section 74, via the A/D converter 58, image data of an image frame that is displayed by the display 26 is also acquired by the delay duration detection section 74, and a frame count of the delay between the respective image data sets is detected to serve as the delay duration.

Next, in step 106, image data outputted from the image capture device 50 is stored at the temporary storage memory 62 in amounts corresponding to the delay duration detected by the delay duration detection section 74, and the routine proceeds to step 108. In other words, a number of frames of image data corresponding to the delay duration is stored at the temporary storage memory 62.

In step 108, it is determined by the system control section 70 whether or not the shutter button 22 has been full-pressed. When this determination is negative, the routine returns to step 106 and the processing described above is repeated, until the determination of step 108 is positive.

When the shutter button 22 is fully pressed and the determination of step 108 is positive, the routine proceeds to step 110. From the plural image frames stored at the temporary storage memory 62, an image frame previous by the delay duration is selected by the selection section 72 and outputted to the signal processing section 60. The routine proceeds to step 112, and signal processing is applied to the image data of the selected image frame.

Then, in step 114, the image frame corresponding to the selected image is recorded. For example, control is performed by the system control section 70 such that the image data of the image frame selected by the selection section 72 is recorded to the internal memory 84 or the memory card 80 or the like.

In step 116, control is performed by the system control section 70 such that the image frame corresponding to the selected image is displayed at the display 26, and this processing sequence finishes.

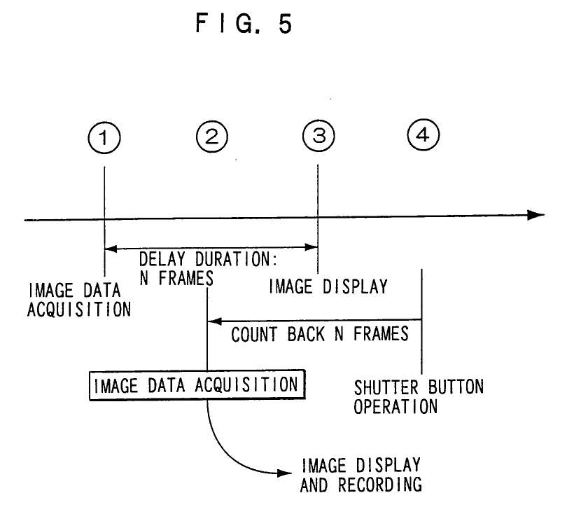

That is, in the present embodiment, the delay duration when the shutter button 22 is operated until an image is displayed at the display 26 is detected, and an image frame which is counted back by the delay duration is displayed at the display 26 and is recorded at the internal memory 84, the memory card 80 or the like. Thus, it is possible to record the same image as the image that is being displayed at the time of operation of the shutter button 22. For example, as shown in FIG. 5, if image data of image frames 1, 2, 3 and 4 is acquired by the image capture device 50 in that order, and the delay duration that is detected by the delay duration detection section 74 is N image frames (two image frames in FIG. 5), N image frames are temporarily stored at the temporary storage memory 62. When the shutter button 22 is operated, the image frame that was N image frames previous is selected by the selection section 72 and outputted. Thus it is possible to eliminate a time lag of display at the time of operation of the shutter button 22, and it is possible to make the image that is recorded the same as the image that is displayed.

Second Embodiment

Next, a digital camera relating to a second embodiment of the present invention will be described. Here, structures of the exterior and the electrical system of the digital camera are basically the same as in the first embodiment. Therefore, descriptions thereof are omitted. Furthermore, in the following descriptions, structures that are the same as in the first embodiment are assigned the same reference numerals for description.

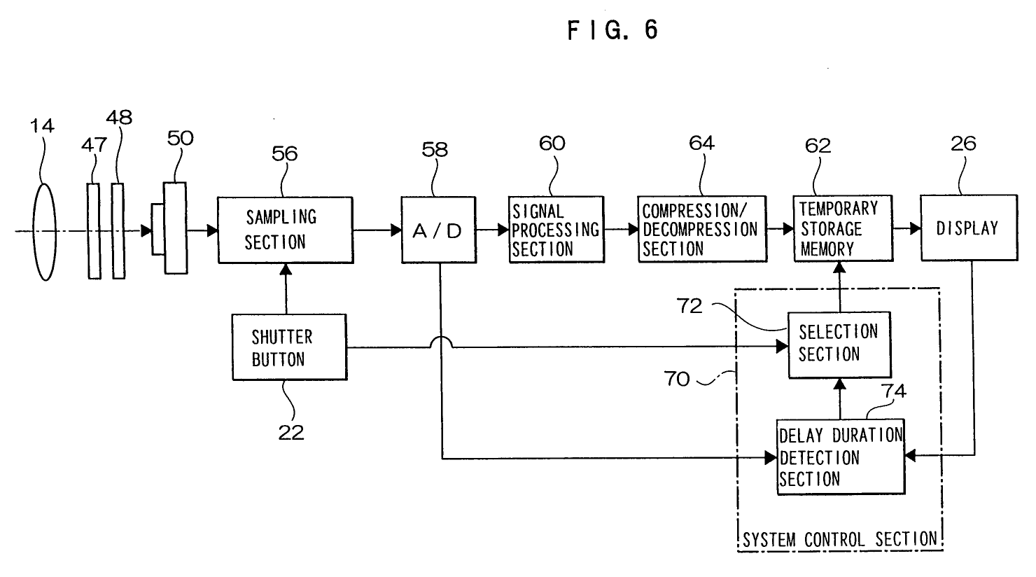

FIG. 6 is a functional block diagram showing detailed structure for when an image is to be displayed at the display 26 of the digital camera relating to the second embodiment of the present invention.

A subject image is imaged at the image capture device 50, via the lens 14, the AF lens 47 and the aperture 48, is outputted from the image capture device 50 as image data, and is inputted to the signal processing section 60 via the above-described sampling section 56 and A/D converter 58.

The image data inputted to the signal processing section 60 is subjected to various treatments by the signal processing section 60 and outputted to the compression/decompression section 64, and compression is applied by the compression/decompression section 64. Thereafter, the image data is outputted to the display 26 while being stored at the temporary storage memory 62. Thus, a through-image is displayed at the display 26. Note that the image data for display of the through-image may be outputted to the display 26 as is, without being compressed.

Similarly to the first embodiment, the system control section 70 is structured to include the selection section 72 and the delay duration detection section 74. The delay duration detection section 74 acquires image data, which is obtained by photography by the image capture device 50, from the A/D converter 58, also acquires image data of an image frame which is displayed at the display 26, and detects a number of frames of a delay between the respective sets of image data to serve as the delay duration (i.e., the delay duration corresponding to the time lag from operation of the shutter button 22 until display at the display 26). In the present embodiment too, the delay duration detection section 74 detects a delay frame count to serve as the delay duration, but could also calculate the delay duration itself from the delay frame count and the sampling rate of the sampling section 56.

Again, the selection section 72 acquires the delay duration detected by the delay duration detection section 74 (i.e., the delay frame count). When the shutter button 22 is operated, from the plural image frames stored at the temporary storage memory 62, the selection section 72 outputs to the signal processing section 60 image data which represents an image frame counted back by the delay duration.

Next, an example of operation of the digital camera relating to the second embodiment of the present invention will be described.

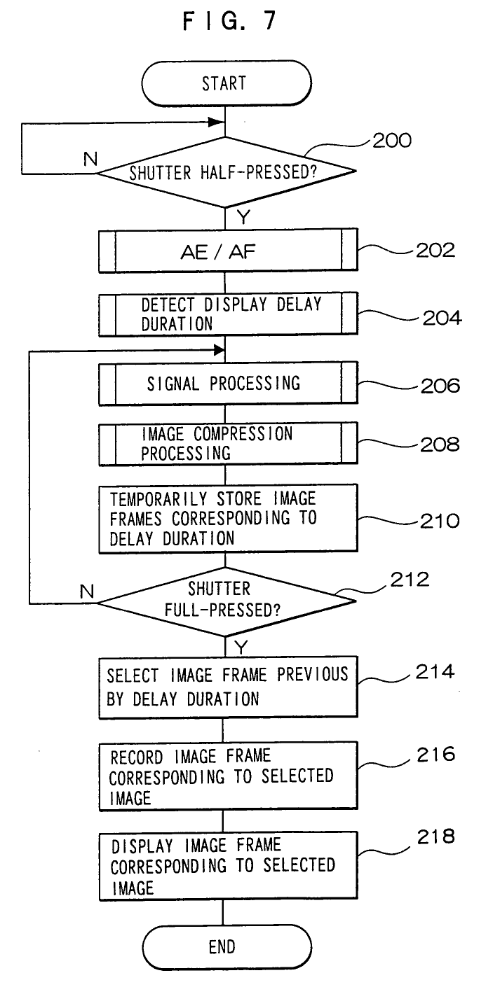

FIG. 7 is a flowchart showing an example of flow of operations of the digital camera relating to the second embodiment of the present invention.

First, in step 200, the system control section 70 determines whether or not the shutter button 22 has been half-pressed. When this determination is negative, the system control section 70 waits, until the determination is positive, and then proceeds to step 202.

In step 202, the AE/AF processing is performed. Known techniques can be employed for the AE/AF processing. For example, for the AE processing, control is performed by the system control section 70 so as to calculate evaluation values for adjusting the aperture 48, on the basis of light amounts of the image data outputted by the image capture device 50, and to adjust the aperture 48. Further, for the AF processing, control is performed by the system control section 70 so as to detect a position of the AF lens 47 at which a contrast value of the image data outputted by the image capture device 50 is maximized and move the AF lens 47, and to detect a position of the AF lens 47 at which a frequency of the image data is at least a predetermined high-frequency component and move the AF lens 47.

Then, in step 204, the display delay duration detection processing is performed. For this processing, image data provided by photography by the image capture device 50 is acquired by the delay duration detection section 74, via the A/D converter 58, image data of an image frame displayed by the display 26 is also acquired by the delay duration detection section 74, and a frame count of the delay is detected from the respective image data sets to serve as the delay duration.

Then, in step 206, signal processing of the various corrections and the like is applied by the signal processing section 60 to the image data acquired by the image capture device 50. The routine proceeds to step 208, and the image data that has been signal-processed is compression-processed by the compression/decompression section 64. As the compression processing, the image data is compressed into, for example, JPEG format. Because it is possible to employ various other well-known compression techniques, a detailed explanation thereof is not given here.

Then, in step 210, image frames corresponding to the delay duration, which have been signal-processed and compressed, are stored at the temporary storage memory 62, and the routine proceeds to step 212.

In step 212, the system control section 70 determines whether or not the shutter button 22 has been fully pressed. When this determination is negative, the routine returns to step 206 and the processing described above is repeated, until the determination of step 212 is positive.

When the shutter button 22 is fully pressed and the determination of step 212 is positive, the routine advances to step 214. From the plural frames stored at the temporary storage memory 62, an image frame previous by an amount corresponding to the delay duration is selected by the selection section 72, and the routine proceeds to step 216.

In step 216, the image frame corresponding to the selected image is recorded. For example, control is performed by the system control section 70 such that image data of the image frame selected by the selection section 72 is recorded to the internal memory 84 or the memory card 80.

Again, in step 218, control is performed by the system control section 70 such that the image frame corresponding to the selected image is displayed at the display 26, and the processing sequence finishes. Incidentally, for the present embodiment, a case of compression in JPEG format is anticipated, so it will be possible to display without decompressing when an image frame is to be displayed at the display 26. However, it would also be possible to perform a display after decompressing compressed image data.

That is, in the present embodiment, similarly to the first embodiment, the delay duration when the shutter button 22 is operated until an image is displayed at the display 26 is detected, and an image frame counted back by the delay duration is displayed at the display 26 and is recorded to the internal memory 84, the memory card 80 or the like. Thus, it is possible to record an image the same as the image that is displayed at the time of operation of the shutter button 22.

Moreover, in the present embodiment, when the image frames corresponding to the delay duration are stored at the temporary storage memory 62, the image frames are stored after compression. Therefore, it is possible to save on capacity of the temporary storage memory 62.

Third Embodiment

Next, a digital camera relating to a third embodiment will be described. Here, structures of the exterior and the electrical system of the digital camera are basically the same as in the first embodiment. Therefore, descriptions thereof are omitted. Furthermore, in the following descriptions, structures that are the same as in the first embodiment are assigned the same reference numerals for description.

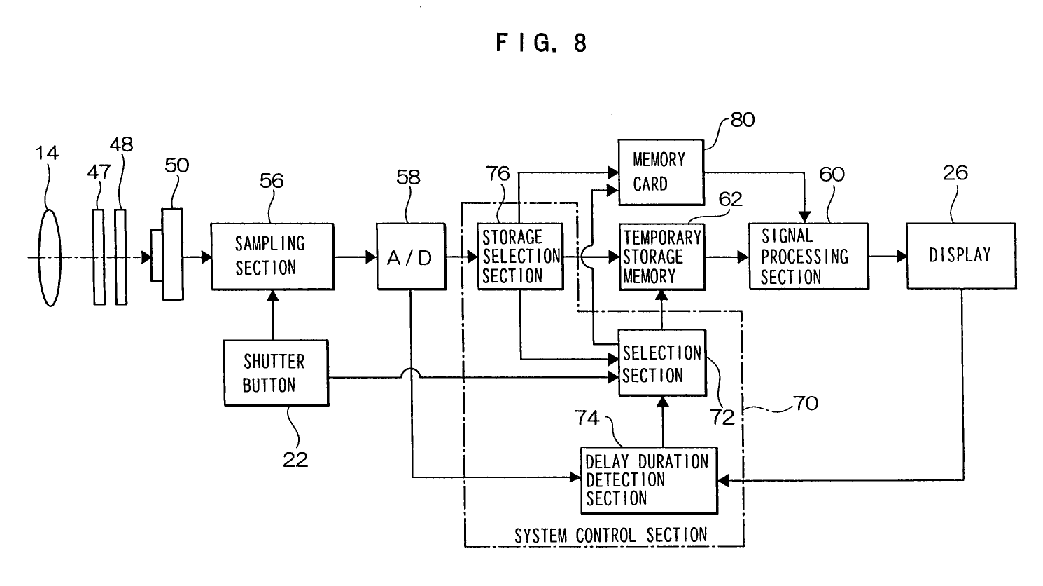

FIG. 8 is a functional block diagram showing detailed structure for when an image is to be displayed at the display 26 of the digital camera relating to the third embodiment.

As shown in FIG. 8, similarly to the first and second embodiments, the system control section 70 of the digital camera relating to the third embodiment is structured to include the selection section 72 and the delay duration detection section 74. In addition, in the third embodiment, the system control section 70 is structured to also include a storage selection section 76.

A subject image is imaged at the image capture device 50, via the lens 14, the AF lens 47 and the aperture 48, is outputted from the image capture device 50 as image data and, via the aforementioned sampling section 56 and A/D converter 58, is stored at the temporary storage memory 62 or the memory card 80, whichever is selected by the storage selection section 76, while being outputted to the signal processing section 60. Then, the various treatments are applied by the signal processing section 60, after which the image data is outputted to the display 26. Thus, a through-image is displayed at the display 26.

The storage selection section 76 detects spare capacity of the temporary storage memory 62 and, if the vacant capacity is small (i.e., if it will not be possible to store image frames corresponding to the delayed duration, if the vacant capacity is less than a pre-specified volume, or the like), the storage selection section 76 switches a temporary storage destination to an external storage device, such as the memory card 80. The storage selection section 76 also notifies the selection section 72 of the temporary storage destination that has been selected.

Similarly to the embodiments described earlier, the delay duration detection section 74 acquires image data, which is obtained by photography by the image capture device 50, from the A/D converter 58, also acquires image data of an image frame which is displayed at the display 26, and detects a number of frames of a delay between the respective sets of image data to serve as the delay duration (i.e., the delay duration corresponding to the time lag from operation of the shutter button 22 until display at the display 26). In the present embodiment too, the delay duration detection section 74 detects a delay frame count to serve as the delay duration, but could also calculate the delay duration itself from the delay frame count and the sampling rate of the sampling section 56.

Again, the selection section 72 acquires the delay duration detected by the delay duration detection section 74 (i.e., the delay frame count). When the shutter button 22 is operated, from the plural image frames stored at the storage destination of which the selection section 72 has been notified by the storage selection section 76 (in the present embodiment, either the temporary storage memory 62 or the memory card 80), the selection section 72 outputs image data which represents an image frame counted back by the delay duration to the signal processing section 60.

Next, an example of operation of the digital camera relating to the third embodiment of the present invention, which is structured as described above, will be described.

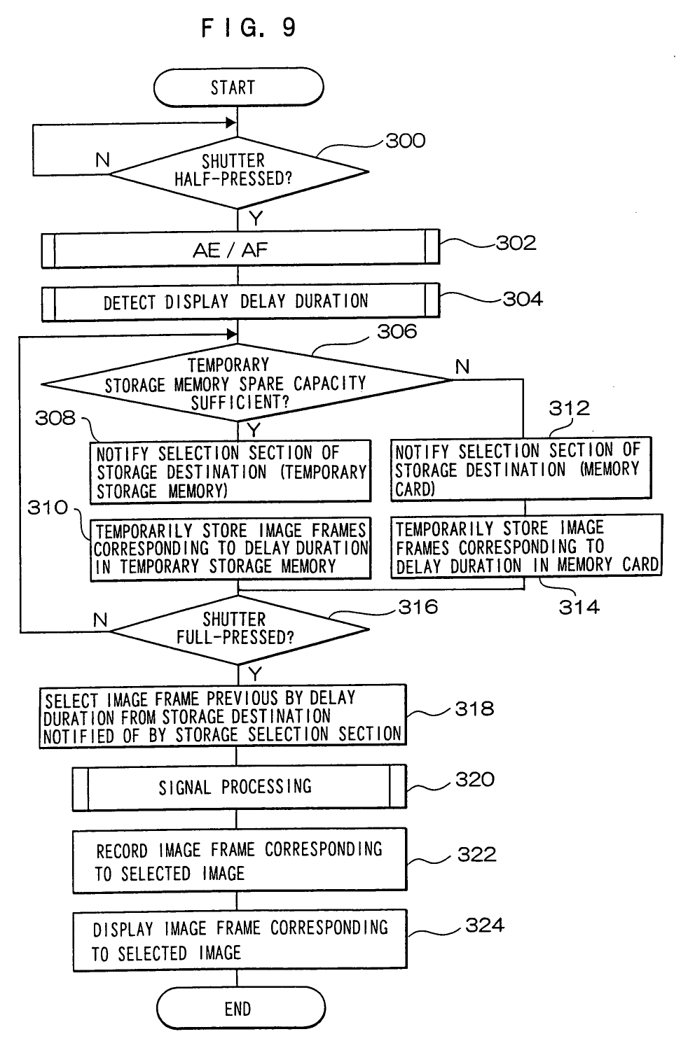

FIG. 9 is a flowchart showing an example of flow of operations of the digital camera relating to the third embodiment of the present invention.

First, in step 300, the system control section 70 determines whether or not the shutter button 22 has been half-pressed. When this determination is negative, the system control section 70 waits, until the determination is positive, and then proceeds to step 302.

In step 302, the AE/AF processing is performed. Known techniques can be employed for the AE/AF processing. For example, for the AE processing, control is performed by the system control section 70 so as to calculate evaluation values for adjusting the aperture 48, on the basis of light amounts of the image data outputted by the image capture device 50, and to adjust the aperture 48. For the AF processing, control is performed by the system control section 70 to detect a position of the AF lens 47 at which a contrast value of the image data outputted by the image capture device 50 is maximized and move the AF lens 47, and to detect a position of the AF lens 47 at which a frequency of the image data is at least a predetermined high-frequency component and move the AF lens 47.

Then, in step 304, the display delay duration detection processing is performed. For this processing, image data provided by photography by the image capture device 50 is acquired by the delay duration detection section 74, via the A/D converter 58, and image data of an image frame displayed by the display 26 is also acquired by the delay duration detection section 74. A frame count of the delay is detected from the respective image data sets to serve as the delay duration.

Next, in step 306, it is determined by the storage selection section 76 whether or not a spare capacity of the temporary storage memory 62 is sufficient. If this determination is positive, the routine advances to step 308, and the selection section 72 is notified by the storage selection section 76 of the selected storage destination (i.e., the temporary storage memory 62). The routine proceeds to step 310, the image data outputted from the image capture device 50 is stored at the temporary storage memory 62 to an amount corresponding to the delay duration detected by the delay duration detection section 74, and the routine proceeds to step 316. Thus, a number of frames of image data which corresponds to the delay duration is stored at the temporary storage memory 62.

On the other hand, if the determination of step 306 is negative, the routine advances to step 312, and the selection section 72 is notified by the storage selection section 76 of the selected storage destination (i.e., the memory card 80). The routine proceeds to step 314, the image data outputted from the image capture device 50 is stored at the memory card 80 to an amount corresponding to the delay duration detected by the delay duration detection section 74, and the routine proceeds to step 316. Thus, when the spare capacity of the temporary storage memory 62 is insufficient, a number of frames of image data which corresponds to the delay duration is stored at the memory card 80, and it is possible to avoid being unable to store image frames in the amount corresponding to the delay duration because of a memory shortage.

In step 316, the system control section 70 determines whether or not the shutter button 22 has been full-pressed. When this determination is negative, the routine returns to step 306 and the processing described above is repeated, until the determination of step 316 is positive.

When the shutter button 22 is fully pressed and the determination of step 316 is positive, the routine proceeds to step 318. From the plural image frames stored at the storage destination that the storage selection section 76 has specified, an image frame previous by an amount corresponding to the delay duration is selected by the selection section 72 and outputted to the signal processing section 60. The routine proceeds to step 320, and signal processing is carried out on the image data of the selected image frame.

In step 322, the image frame corresponding to the selected image is recorded. For example, control is performed by the system control section 70 such that image data of the image frame selected by the selection section 72 is recorded to the internal memory 84 or the memory card 80.

Then, in step 324, control is performed by the system control section 70 such that the image frame corresponding to the selected image is displayed at the display 26, and the processing sequence finishes.

That is, in the present embodiment, similarly to the first embodiment, the delay duration when the shutter button 22 is operated until an image is displayed at the display 26 is detected, and an image frame counted back by the delay duration is displayed at the display 26 and is recorded to the internal memory 84, the memory card 80 or the like. Thus, at the time of operation of the shutter button 22, it is possible to display an image at the display 26 without a time lag and it is possible to record an image the same as the display image.

Furthermore, with the present embodiment, a storage destination of the image frames corresponding to the delay duration is switched to the temporary storage memory 62 or the external memory card 80 depending on spare capacity of the temporary storage memory 62. Thus, it is possible to utilize memory efficiently.

In the third embodiment, when the image frames corresponding to the delay duration are being stored to the temporary storage memory 62 or the memory card 80, the image frames may be stored after compression, as in the second embodiment. In other words, the second embodiment and the third embodiment may be combined.

In each of the embodiments described above, a delay duration is detected by the delay duration detection section 74. However, a delay duration may be measured beforehand and preparatorily stored at a storage device, such as the internal memory 84 or the like, and this stored delay duration can be retrieved.

Anyway, according to the photography device of the present invention, image data representing a subject image is acquired by photography of the subject image by an image capture device. A photography instruction is implemented by an instruction section. Further, display of an image based on the image data acquired by the image capture device is implemented at the display section.

There is a time lag from acquisition of image data by the image capture device until display, and there is a mismatch between an image at the moment that photography is instructed by the instruction section and an image that is displayed at the display section.

Accordingly, in the photography device of the present invention, the delay duration, which is from acquisition of image data by the image capture device until image display by the display section, is acquired by an acquisition section, and the image data that the image capture device acquires is stored by the storage section. That is, image data corresponding to an image that will be displayed at the display section at the moment that photography is instructed by the instruction section is stored at the storage section.

Then, when photography is instructed by the instruction section, a selection section selects image data corresponding to a time previous by the delay duration which has been acquired by the acquisition section, from the image data stored at the storage section. That is, the selected image data is an image which is not mismatched with the image being displayed at the display section at the time that photography is instructed. Hence, display, recording and the like are carried out using this image data, and it is possible to record and display an image without a mismatch with the image that was displayed at the display section when photography was instructed.

Now, the photography device of the present invention may be further provided with a compression section which compresses the image data acquired by the image capture device, and the storage section may store the image data which has been compressed by the compression section. When this image data which has been compressed is stored, it is possible to save on capacity of the storage section.

Furthermore, the photography device of the present invention may be further provided with: an external storage section, which stores the image data which the image capture device acquires; and a storage selection section, which selects a storage destination for the image data. When the external storage section and storage selection section are additionally provided thus, it is possible to store to the external storage section when there is a shortage of storage capacity of the storage section, and it is possible to utilize the storage section efficiently.

Further, when a control section is further provided which controls the display section so as to implement display on the basis of the image data selected by the selection section and which controls such that the image data selected by the selection section is recorded to a recording medium, it is possible to make an image that is displayed by the display section and an image that is recorded the same image.

Further yet, if the storage section stores the image data in an amount corresponding to at least the delay duration acquired by the acquisition section, it is possible to display an image of a moment at which photography is instructed.

Herein, the acquisition section may include a detection section, which detects the delay duration, or a delay duration storage section, which stores a pre-specified delay duration, and acquire the delay duration from the detection section or the delay duration storage section.

Further, according to a photography processing method of the present invention, in an image capture step, image data representing a subject image is acquired by photographing the subject image. Then, in a display step, display of an image based on the image data which has been acquired by the image capture step is implemented.

As mentioned above, there is a time lag from acquisition of image data in the image capture step till display, and there is a mismatch between an image at the moment that photography is instructed and an image that is displayed in the display step.

Accordingly, in the photography processing method of the present invention, the delay duration, which is from acquisition of the image data by the image capture step until image display by the display step, is acquired in an acquisition step, and the image data acquired in the image capture step is stored in a storage step. That is, image data corresponding to an image that will be displayed at the display step at the moment that photography is instructed is stored by the storage step.

Then, when photography is instructed, in a selection step, image data corresponding to a time previous by the delay duration, which has been acquired by the acquisition step, is selected from the image data stored by the storage step. That is, the selected image data is an image which is not mismatched with the image being displayed at the display step when photography is instructed. Hence, display, recording and the like are carried out using this image data, and it is possible to record and display an image without a mismatch with the image that was displayed at the display section when photography was instructed.

Herein, a compression step for compressing the image data acquired in the image capture step may be further provided, with the storage step storing the image data which has been compressed in the compression step. When this image data which has been compressed is stored, it is possible to save on capacity of memory that is used in the storage step.

Furthermore, a storage selection step of selecting a storage destination, which stores the image data in the storage step, may be further provided. When a storage selection step is additionally included thus, it is possible to store at a different storage destination when there is a shortage of storage capacity, and it is possible to utilize memory that is employed in the storage step efficiently.

Further, when a control step is further provided, for controlling in the display step such that display is implemented on the basis of the image data selected in the selection step and for controlling such that the image data selected in the selection step is recorded to a recording medium, it is possible to make an image that is displayed in the display step and an image that is recorded the same image.

Further yet, if the storage step includes storing the image data in an amount corresponding to at least the delay duration acquired by the acquisition step, it is possible to display an image of a moment at which photography is instructed.

Herein, the acquisition step may include a detection step, for detecting the delay duration, or a delay duration storage step, for storing a pre-specified delay duration, and include acquiring the delay duration detected in the detection step or the delay duration stored in the delay duration storage step.

According to the present invention as described above, image data representing a subject image is preparatorily stored at a storage section. When photography is instructed, image data corresponding to a time previous by a delay duration, from acquisition of image data till display, is selected from the stored image data. As a result, there is a benefit in that it is possible to perform display and recording of an image based on image data that is displayed at a moment at which photography is instructed, and it is possible to record and display an image without a mismatch thereof with an image that was displayed at a display section when photography was instructed.

What is claimed is:

1. A photography device comprising:
an image capture device, which acquires image data representing a subject image by photographing the subject image;
an instruction section for instructing photography;
a display section, which implements display on the basis of the image data acquired by the image capture device;
an acquisition section which acquires a delay duration, which is the duration of the delay from acquisition of the image data by the image capture device until the display section displays a corresponding image;
a storage section, which stores the image data which the image capture device acquires; and
a selection section which, at a time at which photography is instructed by the instruction section, selects, from the image data stored at the storage section, image data that corresponds to a time previous to the time at which photography is instructed by the delay duration acquired by the acquisition section.

2. The photography device of claim 1, further comprising a compression section, which compresses the image data acquired by the image capture device, wherein the storage section stores the image data which has been compressed by the compression section.

3. The photography device of claim 2, further comprising:
an external storage section, which stores the image data which the image capture device acquires; and
a storage selection section, which selects a storage destination for the image data.

4. The photography device of claim 1, further comprising:
an external storage section, which stores the image data which the image capture device acquires; and
a storage selection section, which selects a storage destination for the image data.

5. The photography device of claim 1, further comprising a control section, which controls the display section so as to implement display on the basis of the image data selected by the selection section and which controls such that the image data selected by the selection section is recorded to a recording medium.

6. The photography device of claim 1, wherein the storage section stores the image data in an amount corresponding to at least the delay duration acquired by the acquisition section.

7. The photography device of claim 1, wherein the acquisition section comprises at least one of a detection section, which detects the delay duration, and a delay duration storage section, which stores a pre-specified delay duration, and the acquisition section acquires the delay duration from one of the detection section and the delay duration storage section.

8. A photography processing method comprising:
an image capture step, for acquiring image data representing a subject image by photographing the subject image;
a display step, for implementing display on the basis of the image data acquired by the image capture step;
an acquisition step, for acquiring a delay duration, which is the duration of the delay from acquisition of the image data in the image capture step until a corresponding image is displayed in the display step;
a storage step, for storing the image data acquired by the image capture step; and
a selection step of, at a time at which photography is instructed, selecting, from the image data stored by the storage step, image data that corresponds to a time previous to the time at which photography is instructed by the delay duration acquired in the acquisition step.

9. The photography processing method of claim 8, further comprising a compression step for compressing the image data acquired in the image capture step, wherein the storage step includes storing the image data which has been compressed in the compression step.

10. The photography processing method of claim 9, further comprising a storage selection step of selecting a storage destination, which stores the image data in the storage step.

11. The photography processing method of claim 8, further comprising a storage selection step of selecting a storage destination, which stores the image data in the storage step.

12. The photography processing method of claim 8, further comprising a control step, for controlling in the display step such that display is implemented on the basis of the image data selected in the selection step and for controlling such that the image data selected in the selection step is recorded to a recording medium.

13. The photography processing method of claim 8, wherein the storage step includes storing the image data in an amount corresponding to at least the delay duration acquired by the acquisition step.

14. The photography processing method of claim 8, wherein the acquisition step includes at least one of a detection step, for detecting the delay duration, and a delay duration storage step, for storing a pre-specified delay duration, and the acquisition section includes acquiring one of the delay duration detected in the detection step and the delay duration stored in the delay duration storage step.
